(19) United States
(12) Patent Application Publication
(10) Pub. No.: US 2019/0286879 A1
(43) Pub. Date: Sep. 19, 2019

(54) FINGERPRINT RECOGNITION CONTROL METHODS, TOUCH PANELS AND TOUCH DISPLAY DEVICES

(71) Applicant: KunShan Go-Visionox Opto-Electronics Co., Ltd., Kunshan (CN)

(72) Inventors: Wenxing LI, Kunshan (CN); Xinquan CHEN, Kunshan (CN); Zheng WANG, Kunshan (CN)

(73) Assignee: KunShan Go-Visionox Opto-Electronics Co., Ltd., Kunshan (CN)

(21) Appl. No.: 16/430,612

(22) Filed: Jun. 4, 2019

Related U.S. Application Data
(63) Continuation of application No. PCT/CN2018/102448, filed on Aug. 27, 2018.

(30) Foreign Application Priority Data
Dec. 29, 2017 (CN) 201711485073.4

(51) Int. Cl. G06K 9/00; G06F 3/041

(52) U.S. Cl. CPC G06K 9/00087; G06F 3/0412; G06K 9/00013

(57) ABSTRACT

The application relates to the field of touch technology. The application includes: triggering a fingerprint recognition module to start and collecting a first fingerprint information when a fingerprint recognition instruction is detected; searching in a pre-stored fingerprint information list on whether there is a second fingerprint information matching with the first fingerprint information, and if yes, determining that a fingerprint recognition is successful.

### CROSS-REFERENCE TO RELATED APPLICATIONS

This application claims priority to Chinese Patent Application No. 201711485073.4, filed on Dec. 29, 2017, with a title “FINGERPRINT RECOGNITION CONTROL METHOD, TOUCH PANEL AND TOUCH DISPLAY DEVICE”, the entire contents of which are hereby incorporated by reference.

### FIELD

The application relates to the field of touch technology.

### BACKGROUND

With an advent of emerging technologies such as the mobile internet and the Internet of Things, traditional user authentication and recognition methods have been unable to meet the needs of social development. Through a close integration of computers with high-tech means such as optics, acoustics, biosensors and biostatistics, a recognition of personal identity using inherent physiological and behavioral characteristics of a human body has become a trend of the times.

Currently, fingerprint recognition is more common in various application fields.

### SUMMARY

Exemplary embodiments of the application provide fingerprint recognition control methods, touch panels, and touch display devices.

The following technical solutions are adopted by exemplary embodiments of the application:

A fingerprint recognition control method including:

providing at least a fingerprint recognition module and a pre-stored fingerprint information list;

triggering a fingerprint recognition module of the at least a fingerprint recognition module to start and collecting a first fingerprint information when a fingerprint recognition instruction is detected;
searching in the pre-stored fingerprint information list on whether there is a second fingerprint information matching with the first fingerprint information, and if yes, determining that a fingerprint recognition is successful.

Optionally, the fingerprint recognition instruction is an instruction triggered by a touch operation, the method further includes: determining a touch position corresponding to the touch operation;

the triggering a fingerprint recognition module of the at least a fingerprint recognition module includes:
triggering the fingerprint recognition module corresponding to the touch position to start, wherein the touch position is located in a display area of a touch panel.

Optionally, when the current touch panel is in a dark screen state, before the first fingerprint information is collected and after the touch position corresponding to the touch operation is determined, the method further includes: controlling an illuminating sub-pixel corresponding to the control position to light up.

Optionally, wherein a display screen is in a bright screen state, after the fingerprint recognition is successful, the method further includes:

unlocking the screen of the touch panel, or enabling a passed transaction verification, or enabling a passed login verification.

Optionally, wherein the display screen is in a dark screen state, after the fingerprint recognition is successful, the method further includes:

triggering and illuminating a display area of the touch panel, and unlocking the screen of the touch panel, or enabling a passed transaction verification, or enabling a passed login verification.

Optionally, wherein determining the touch position corresponding to the touch operation specifically includes:

detecting a pressing attribute of the touch operation;
when the pressing property satisfies a preset condition, determining an area where the touch operation is implemented as the touch position corresponding to the touch operation.

Optionally, wherein the touch position includes at least one independent area subjected to a touch operation;

the first fingerprint information is at least one fingerprint information which is simultaneously collected by the fingerprint recognition module corresponding to the at least one independent area.

Optionally, wherein the first fingerprint information includes a plurality of fingerprint information collected simultaneously;

searching in the pre-stored fingerprint information list on whether there is the second fingerprint information which matches with the first fingerprint information includes:
traversing the second fingerprint information in the pre-stored fingerprint information list;
finding whether the fingerprint information included in the second fingerprint information is the same as the fingerprint information included in the first fingerprint information.

Optionally, wherein the second fingerprint information in the pre-stored fingerprint information list is added by a touch operation during a setting process, wherein the touch operation includes a single-finger touch operation or a multi-fingers touch operation.

A touch panel, including:

a determining module configured to determine a touch position corresponding to a touch operation when the touch operation is detected, wherein the touch position is located in a display area of a touch panel;
a collecting module configured to trigger a fingerprint recognition module corresponding to the touch position to start, and collect a first fingerprint information; and
a processing module configured to search in a pre-stored fingerprint information list on whether there is second fingerprint information that matches with the first fingerprint information, and if yes, determine that the fingerprint recognition is successful.

Optionally, the control panel further includes:

a control module configured to control, when the touch panel is in a dark screen state, an illuminating sub-pixel corresponding to the control position to light up before the first fingerprint information is collected and after the touch position corresponding to the touch operation is determined.

Optionally, wherein the display screen is in a bright screen state, after the fingerprint recognition is successful, the processing module is further configured to, unlock the screen of the touch panel, or enable a passed transaction verification, or enable a passed login verification.

Optionally, wherein the display screen is in a dark screen state, after the fingerprint recognition is successful, the processing module is further configured to:

i
trigger to illuminate a display area of the touch panel, and
unlock the screen of the touch panel, or enable a passed transaction verification, or enable a passed login verification.

Optionally, wherein the determining module is specifically configured to: detect a pressing attribute of the touch operation; and

determine an area where the touch operation is implemented as the touch position corresponding to the touch operation, when the pressing property satisfies the preset condition.

Optionally, wherein the touch position includes at least one independent area subjected to a touch operation; the first fingerprint information is at least one fingerprint information which is simultaneously collected by the fingerprint recognition module corresponding to the at least one independent area.

Optionally, wherein the first fingerprint information includes a plurality of fingerprint information collected simultaneously, when searching in the pre-stored fingerprint information list on whether there is the second fingerprint information which matches with the first fingerprint information, the processing module is further configured to,

traverse the second fingerprint information in the pre-stored fingerprint information list;
find whether the fingerprint information included in the second fingerprint information is the same as the fingerprint information included in the first fingerprint information.

Optionally, wherein the second fingerprint information in the pre-stored fingerprint information list is added by a touch operation during a setting process, wherein the touch operation includes a single-finger touch operation or a multi-fingers touch operation.

Optionally, the touch panel further includes:

a touch film layer and a fingerprint recognition film layer;
an orthographic projection of the fingerprint recognition film layer on the touch panel at least partially coincides with an orthographic projection of the touch film layer on the touch panel, the fingerprint recognition film layer includes a plurality of fingerprint recognition modules arranged in an array.

Optionally, the touch panel further includes: a processing chip, a display module, and a package cover.

A touch display device includes the above touch panel.

The following beneficial effects can be achieved by the above at least one technical solution adopted by the exemplary embodiment of the application:

Therefore, with the technical solutions of the application, when the fingerprint recognition instruction is received, the corresponding fingerprint recognition module can be started, the specific area does not need to be pressed, the fingerprint recognition modules in the entire fingerprint recognition film layer are not required to start, the power consumption of the screen can be saved, and the fingerprint recognition under the screen of the full screen can be easily realized. Moreover, the fingerprint recognition under the screen can be realized at any position in the display area, and the flexibility and convenience of the fingerprint recognition can be improved.

### BRIEF DESCRIPTION OF THE DRAWINGS

The drawings described herein are intended to provide a further understanding of the application, and are intended to be a part of this application. The illustrative exemplary embodiments of the application and the description thereof are intended for explaining the application and do not constitute an undue limitation to the application. In the drawings:

FIG. 1(a) is a first schematic flowchart view of a fingerprint recognition control method according to an exemplary embodiment of the application;

FIG. 1(b) is a second schematic flowchart view of a fingerprint recognition control method according to an exemplary embodiment of the application;

FIG. 2(a) is a schematic view showing a specific process of step 11b in the fingerprint recognition control method provided by an exemplary embodiment of the application;

FIG. 2(b) is a schematic view showing a part of a specific process of the step 13b in the fingerprint recognition control method according to the exemplary embodiment of the application;

FIG. 3 is a schematic structural view of a touch panel according to an exemplary embodiment of the present application;

FIG. 4 is a schematic structural view of a film layer of a touch panel according to an exemplary embodiment of the application.

### DETAILED DESCRIPTION

At present, in an electronic device such as a mobile phone, a fingerprint recognition module is generally arranged at a Home button of a non-display area, or is arranged at a specific position under a screen of a display area, and prompts a user to recognize a location of the fingerprint in a constantly bright manner.

However, in the existing fingerprint recognition scheme, the position of the fingerprint recognition module is fixed, and a limitation of a fingerprint recognition operation is large. Sometimes an illumination sub-pixel arranged at a position of the fingerprint recognition module needs to be set to be constantly bright, and a power consumption is high and affects a lifetime of a device.

In order to make the objects, the technical solution and the advantages of the application clear, the technical solution of the application will be dearly and completely described in the following with reference to the specific exemplary embodiments of the application and the corresponding drawings. It is apparent that the described exemplary embodiments are only a part of the embodiments of the application rather than all of them. All other embodiments obtained by a person skilled in the art based on the exemplary embodiments of the application without paying creative work fall into the protection scope of the application.

The technical solution provided by the exemplary embodiments of the application is described in detail below with reference to the accompanying drawings.

It should be noted that the fingerprint recognition control solution involved in the application applies to a touch screen with a functional module such as a processor, or an electronic device with the touch screen, such as a mobile phone, a tablet computer, a VR, an AR, a wearable device, or other devices that need to be touched.

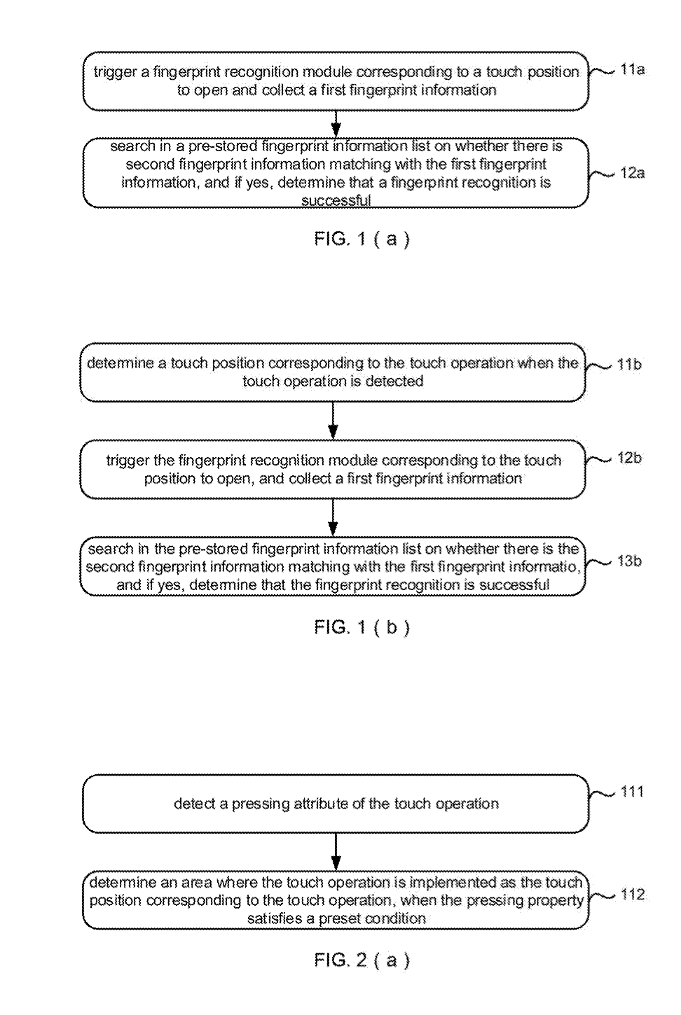

In the application, referring to FIG. 1(a), FIG. 1(a) is a schematic flowchart view of a fingerprint recognition control method according to an exemplary embodiment of the application, the method mainly includes the following steps:

Step 11a: triggering a fingerprint recognition module to start and collecting a first fingerprint information when a fingerprint recognition instruction is detected. In an exemplary embodiment, the fingerprint recognition module may be a fingerprint recognition circuit.

The fingerprint recognition instruction involved may be an instruction triggered by performing a touch operation on the touch panel, or an instruction generated by triggering a voice control or an instruction sent by another terminal.

Step 12a: searching in a pre-stored fingerprint information list on whether there is a second fingerprint information matching with the first fingerprint information, and if yes, determining that a fingerprint recognition is successful.

Therefore, the fingerprint recognition under the screen can be realized at any position in the display area, the flexibility and convenience of the fingerprint recognition can be improved, the power consumption of the screen can be saved, and the fingerprint recognition under the screen of the full screen can be easily realized.

Referring to FIG. 1(b), FIG. 1(b) is a second schematic flowchart view of a fingerprint recognition control method according to an exemplary embodiment of the application. The method mainly includes the following steps:

Step 11b: determining a touch position corresponding to the touch operation when the touch operation is detected.

The touch position is located in a display area of the touch panel. In the application, the touch operation involved can be understood as the operation of the finger pressing any position in the touch screen corresponding to the display area.

In one implementation manner, a touch film layer of the touch panel can determine the touch position corresponding to a position on which the user's finger is pressing according to the touch signal collected by a sensor.

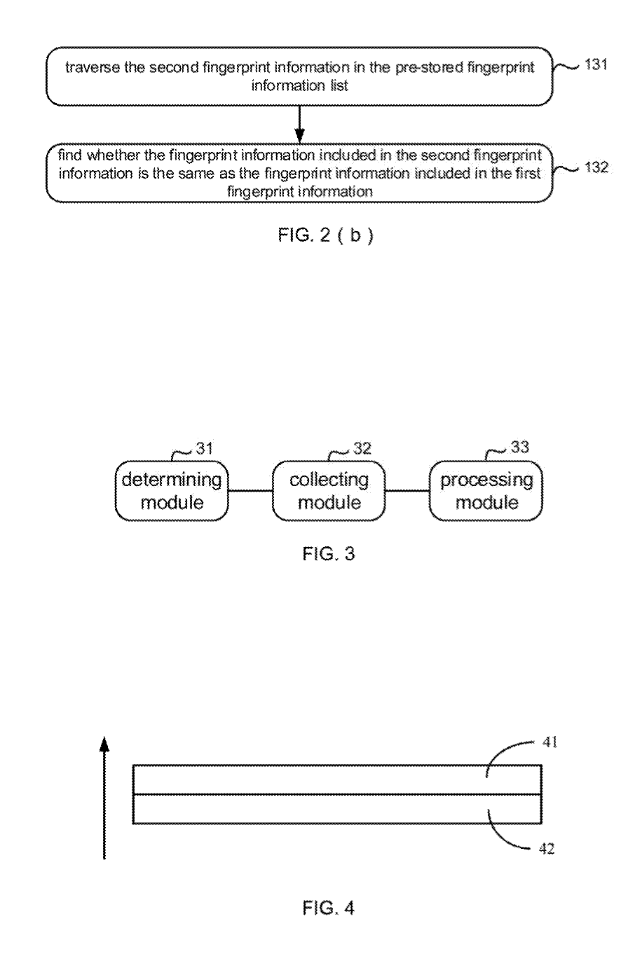

Further, in order to achieve a more accurate acquisition of fingerprint information, referring to FIG. 2(a), in step 11b, the following operations are specifically performed as follows:

Step 111: detecting a pressing attribute of the touch operation.

Step 112: determining an area where the touch operation is implemented as the touch position corresponding to the touch operation, when the pressing property satisfies the preset condition.

In the application, for the touch operation, the pressing attribute may include: pressing force, pressing time, pressing manner, and the like. The pressing manner can be understood as a contact pressing or a non-contact pressing (i.e., a somatosensory pressing that is achieved by not touching the touch panel), or a rotational pressing in a certain direction after pressing, or a sliding operation or the like.

For example, when any position of the display area of the touch panel is detected to be touch-operated, the pressing force of the touch operation is detected. When the pressing force is greater than a first threshold, the area where the touch operation is implemented is determined as a touch position corresponding to the touch operation.

For example, when any position of the display area of the touch panel is detected to be touch-operated, the pressing time of the touch operation is detected, When the pressing time is greater than a second threshold, the area where the touch operation is implemented is determined as a touch position corresponding to the touch operation.

For example, when any position of the display area of the touch panel is detected to be touch-operated, the pressing force and the pressing time of the touch operation are detected, when the pressing force is greater than the first threshold and the pressing time is greater than the second threshold, the area where the touch operation is implemented is determined as a touch position corresponding to the touch operation.

Step 12b: triggering the fingerprint recognition module corresponding to the touch position to start, and collecting a first fingerprint information.

In the application, since the fingerprint recognition film layer corresponding to the fingerprint recognition module is arranged on the surface of the entire touch film layer, after determining the touch position corresponding to the touch operation, the fingerprint recognition modules corresponding to the entire fingerprint recognition film layer are not needed to start, and only the fingerprint recognition module at an area corresponding to the touch position is needed to start, so as to collect the fingerprint of the user performing the touch operation.

Specifically, after determining the touch position corresponding to the touch operation, the fingerprint recognition module corresponding to the touch position may be further determined according to the determined touch position, and then the fingerprint recognition module corresponding to the touch position is triggered to start to collect the first fingerprint information.

In the application, the means of collecting the first fingerprint information is optical fingerprint recognition, and correspondingly, it may be an infrared sensing element or other optical sensing elements. Then, in the exemplary embodiment, after the touch position is determined, the fingerprint recognition module is triggered to start, then the first fingerprint information is collected. This process may be regarded as the touch panel being always in a bright screen state; the fingerprint image at the touch position is collected to obtain the first fingerprint information by means of the light source supplied by the display film layer of the touch panel.

Optionally, in the application, in the case of the current touch panel is in a dark screen state, before the first fingerprint information is collected and after the touch position corresponding to the touch operation is determined, the method further includes: controlling an illuminating sub-pixel corresponding to the control position to light up. Therefore, the illuminating sub-pixel arranged below the touch film layer is partially lit up to assist the fingerprint recognition operation to provide a light source, thereby saving the screen power consumption; and the fingerprint recognition area can be highlighted to the user through the wake-up mode, to facilitates implementation of fingerprint pressing recognition.

Step 13b: searching in the pre-stored fingerprint information list on whether there is the second fingerprint information matching with the first fingerprint information, and if yes, determining that the fingerprint recognition is successful.

After the first fingerprint information is collected, the first fingerprint information is compared with the second fingerprint information in the pre-stored fingerprint information list to perform fingerprint recognition.

The second fingerprint information in the pre-stored fingerprint information list is added by a touch operation during a setting process, wherein the touch operation includes a single-finger touch operation or a multi-fingers touch operation.

For example, the fingerprint information list is equivalent to a fingerprint database formed by a fingerprint collected in advance, and the fingerprint database includes a plurality of second fingerprint information which may be multiple second fingerprint information of the same user, for example, a screen unlocking fingerprint information of the user A—the fingerprint information of a left thumb, a transaction verification fingerprint information—the fingerprint information of a right index finger, a logging verification fingerprint information—the fingerprint information of the left index finger, and the like.

Optionally, in the application, the touch position includes at least one independent area subjected to a touch operation; the first fingerprint information is at least one fingerprint information which is simultaneously collected by the fingerprint recognition module corresponding to at least one independent area.

Optionally, the first fingerprint information includes a plurality of fingerprint information collected simultaneously. Correspondingly, step 13b of searching in the pre-stored fingerprint information list on whether there is second fingerprint information which matches with the first fingerprint information specifically includes:

Step 131: traversing the second fingerprint information in the pre-stored fingerprint information list.

Step 132: finding whether the fingerprint information included in the second fingerprint information is the same as the fingerprint information included in the first fingerprint information.

For example, the first fingerprint information is collected when the touch panel is simultaneously touched and pressed by a left thumb of a user A and a right thumb of a user B. Then, when performing comparison of various fingerprint information, it is necessary to find out whether the second fingerprint information including both the fingerprint information of the left thumb of the user A and the fingerprint information of the right thumb of the user B exists in the pre-stored fingerprint information list, If yes, the fingerprint recognition is successful, otherwise, the fingerprint recognition fails.

Therefore, by the technical solution of the application, the startup of a corresponding fingerprint recognition module can be achieved by pressing any position of the display area of the touch panel without pressing a specific area, and without starting the fingerprint recognition module in the entire fingerprint recognition film layer as well, the power consumption of the screen can be saved, and the fingerprint recognition under the screen of the full screen can be easily realized. In addition, the fingerprint recognition under the screen can be realized at any position in the display area, the flexibility and convenience of the fingerprint recognition can be improved.

In fact, in the application, in a case of the display screen being in a bright screen state, after the fingerprint recognition is successful, the method further includes: unlocking the screen of the touch panel, or enabling a passed transaction verification, or enabling a passed login verification. In a case of the display screen being in a dark screen state, after the fingerprint recognition is successful in the case of partially lighting the illuminating sub-pixel, the method further includes: triggering to illuminate a display area of the touch panel, and/or unlocking the screen of the touch panel, or, enabling a passed transaction verification, or enabling a passed login verification.

In an exemplary embodiment of the application, a touch panel is further provided which belongs to the same concept as the above-mentioned fingerprint recognition control method. Referring to FIG. 3, the touch panel mainly includes:

a determining module 31 configured to determine a touch position corresponding to a touch operation when the touch operation is detected, wherein the touch position is located in a display area of a touch panel; in an exemplary embodiment, the determining module 31 may be a determining circuit 31;

a collecting module 32 configured to trigger a fingerprint recognition module corresponding to the touch position to start, and collect a first fingerprint information; in an exemplary embodiment, the collecting module 32 may be a collecting circuit 32; and

a processing module 33 configured to search in the pre-stored fingerprint information list on whether there is the second fingerprint information that matches with the first fingerprint information, and if yes, determine that a fingerprint recognition is successful; in an exemplary embodiment, the processing module 33 may be a processing circuit 33.

In addition, the touch panel further includes at least one other module (or called elements) which controls the display.

Optionally, in the exemplary embodiment of application, the touch panel further includes:

a control module configured to control, when the touch panel is in a dark screen state, an illuminating sub-pixel corresponding to the control position to light up before the first fingerprint information is collected and after the touch position corresponding to the touch operation is determined. In an exemplary embodiment, the control module may be a control circuit.

Optionally, in the application, after the fingerprint recognition is successful, the processing module is further configured to:

trigger to light up a display area of the touch panel, and/or unlock a screen of the touch panel.

Optionally, in the application, the determining module is specifically configured to:

detect a pressing attribute of the touch operation;
determine when the pressing attribute satisfies the preset condition, the area where the touch operation is implemented as a touch position corresponding to the touch operation.

Optionally, the touch position includes at least one independent area in which the touch operation is implemented; the first fingerprint information is at least one fingerprint information which is simultaneously collected by the fingerprint recognition module corresponding to the at least one independent area.

Optionally, the first fingerprint information includes multiple fingerprint information collected at the same time;

when searching in the pre-stored fingerprint information list on whether there is second fingerprint information which matches the first fingerprint information, the processing module is specifically configured to:
traverse the second fingerprint information in the pre-stored fingerprint information list;
find whether the fingerprint information included in the second fingerprint information is the same as the fingerprint information included in the first fingerprint information.

Optionally, the second fingerprint information in the pre-stored fingerprint information list is added by a touch operation during the setting process, wherein the touch operation includes a single-finger touch operation or a multi-fingers touch operation.

In the application, a touch panel is further provided. Referring specifically to a schematic view of the hardware structure of the touch panel shown in FIG. 4, the touch panel mainly includes:

a touch film layer 41, a fingerprint recognition film layer 42 arranged at a light-incident side of the touch film layer 41; the fingerprint recognition film layer 42 may also be arranged on a side other than the light-incident side of the touch film layer 41;

wherein an orthographic projection of the fingerprint recognition film layer 42 on the touch panel coincides with an orthographic projection of the touch film layer 41 on the touch panel. The fingerprint recognition film layer includes a plurality of fingerprint recognition modules arranged in an array. It should be noted that the fingerprint recognition film layer 42 and the touch film layer 41 of the application are both patterned, and the orthographic projections of the two are at least partially overlapped, which in fact means that the fingerprint recognition film layer 42 is arranged on the entire surface of the touch film layer 41. The “arrange” here is only a positional relationship which does not mean that the two must be in direct contact. In fact, an intermediate film layer can also be provided between the two, and the specific film layer relationship can be set according to the design of actual film layer.

In addition, the touch panel further includes a processing chip, a display module (or called a display), a package cover, and the like.

With the above technical solution, the fingerprint recognition film layer is arranged on the entire surface at the light incident side of the touch film layer, thereby ensuring the fingerprint recognition at any position of the display area of the touch panel, improving the flexibility and convenience of the fingerprint recognition.

Meanwhile, an exemplary embodiment of the application also proposes a display device including the touch panel. In addition, the display device can be any product or component with a display function, such as a mobile phone, a tablet computer, a television, a display, a notebook computer, a digital photo frame, a navigator, a smart wearable device, and the like. Other indispensable components of the display device are understood by a person skilled in the art, and are not described herein, nor should they be construed as an limitation to the application.

The above description only shows exemplary embodiments of the application and is not intended to limit the application. Various changes and modifications can be made to the application by a person skilled in the art. Any modifications, equivalents, improvements, etc. made within the spirit and principle of the application are intended to fall into the scope of the appended claims.

claims.

What is claimed is:

1. A fingerprint recognition control method, comprising: providing at least a fingerprint recognition circuit and a pre-stored fingerprint information list;
triggering a fingerprint recognition circuit of the at least a fingerprint recognition circuit to start and collect a first fingerprint information when a fingerprint recognition instruction is detected;
searching in the pre-stored fingerprint information list on whether there is a second fingerprint information matching with the first fingerprint information, and if yes, determining that a fingerprint recognition is successful.

2. The fingerprint recognition control method according to claim 1, wherein the fingerprint recognition instruction is an instruction triggered by a touch operation, the method further comprises: determining a touch position corresponding to the touch operation;
the triggering a fingerprint recognition circuit of the at least a fingerprint recognition circuit comprises:
triggering the fingerprint recognition circuit corresponding to the touch position to start, wherein the touch position is located in a display area of a touch panel.

3. The fingerprint recognition control method according to claim 2, when the current touch panel is in a dark screen state, before the first fingerprint information is collected and after the touch position corresponding to the touch operation is determined, the method further comprises:
controlling an illuminating sub-pixel corresponding to the control position to light up.

4. The fingerprint recognition control method according to claim 1, wherein a display screen is in a bright screen state, after the fingerprint recognition is successful, the method further comprises:
unlocking the screen of the touch panel, or enabling a passed transaction verification, or enabling a passed login verification.

5. The fingerprint recognition control method according to claim 1, wherein the display screen is in a dark screen state, after the fingerprint recognition is successful, the method further comprises:
triggering to illuminate a display area of the touch panel, and
unlocking the screen of the touch panel, or enabling a passed transaction verification, or enabling a passed login verification.

6. The fingerprint recognition control method according to claim 2, wherein the determining the touch position corresponding to the touch operation specifically comprises:
detecting a pressing attribute of the touch operation;
when the pressing property satisfies a preset condition, determining an area where the touch operation is implemented as the touch position corresponding to the touch operation.

7. The fingerprint recognition control method according to claim 2, wherein the touch position comprises at least one independent area subjected to a touch operation;
the first fingerprint information is at least one fingerprint information simultaneously collected by the fingerprint recognition circuit corresponding to the at least one independent area.

8. The fingerprint recognition control method according to claim 7, wherein the first fingerprint information comprises a plurality of fingerprint information collected simultaneously;
the searching in the pre-stored fingerprint information list on whether there is the second fingerprint information matching with the first fingerprint information comprises:
traversing the second fingerprint information in the pre-stored fingerprint information list;
finding whether the fingerprint information included in the second fingerprint information is the same as the fingerprint information included in the first fingerprint information.

9. The fingerprint recognition control method according to claim 1, wherein the second fingerprint information in the pre-stored fingerprint information list is added by a touch operation during a setting process, the touch operation including a single-finger touch operation or a multi-fingers touch operation.

10. A touch panel, comprising:
a determining circuit, the determining circuit determining a touch position corresponding to a touch operation when the touch operation is detected, the touch position being located in a display area of a touch panel;
a collecting circuit, the collecting circuit triggering a fingerprint recognition circuit corresponding to the touch position to start and collecting a first fingerprint information; and
a processing circuit, the processing circuit searching in a pre-stored fingerprint information list on whether there is a second fingerprint information matching with the first fingerprint information, and if yes, determining that a fingerprint recognition is successful.

11. The touch panel according to claim 10, further comprising:
a control circuit controlling, when the touch panel is in a dark screen state, an illuminating sub-pixel corresponding to the control position to light up, before the first fingerprint information is collected and after the touch position corresponding to the touch operation is determined.

12. The touch panel according to claim 10, wherein the display screen is in a bright screen state, after the fingerprint recognition is successful, the processing circuit further
unlocking the screen of the touch panel, or enabling a passed transaction verification, or enabling a passed login verification.

13. The touch panel according to claim 10, wherein the display screen is in a dark screen state, after the fingerprint recognition is successful, the processing circuit further:
triggering to illuminate a display area of the touch panel, and
unlocking the screen of the touch panel, or enabling a passed transaction verification, or enabling a passed login verification.

14. The touch panel according to claim 10, wherein the determining circuit:
detecting a pressing attribute of the touch operation; and
determining an area where the touch operation is implemented as the touch position corresponding to the touch operation, when the pressing property satisfies a preset condition.

15. The touch panel according to claim 10, wherein the touch position comprises at least one independent area subjected to a touch operation; the first fingerprint information is at least one fingerprint information simultaneously collected by the fingerprint recognition circuit corresponding to the at least one independent area.

16. The touch panel according to claim 15, wherein the first fingerprint information comprises a plurality of fingerprint information collected simultaneously;
when searching in the pre-stored fingerprint information list on whether there is the second fingerprint information matching with the first fingerprint information, the processing circuit
traversing the second fingerprint information in the pre-stored fingerprint information list;
finding whether the fingerprint information included in the second fingerprint information is the same as the fingerprint information included in the first fingerprint information.

17. The touch panel according to claim 10, wherein the second fingerprint information in the pre-stored fingerprint information list is added by a touch operation during a setting process, wherein the touch operation includes a single-finger touch operation or a multi-fingers touch operation.

18. The touch panel according to claim 10, further comprising:
a touch film layer and a fingerprint recognition film layer;
wherein, an orthographic projection of the fingerprint recognition film layer on the touch panel at least partially coincides with an orthographic projection of the touch film layer on the touch panel, and the fingerprint recognition film layer comprises a plurality of fingerprint recognition circuits arranged in an array.

19. The touch panel according to claim 18, further comprising: a processing chip, a display, and a package cover.

20. A touch display device comprising the touch panel according to claim 10.
